(19) United States
(12) Patent Application Publication
(10) Pub. No.: US 2015/0358554 A1
(43) Pub. Date: Dec. 10, 2015

(54) Proactively Selecting a Multisource Video Presentation Mode of Operation

(71) Applicant: Dell Products L.P., Round Rock, TX (US)

(72) Inventors: Seen Yee Cindy Cheong, Singapore (SG); Liam B. Quinn, Austin, TX (US); Chee Soo Tan, Singapore (SG)

(73) Assignee: DELL PRODUCTS L.P., Round Rock, TX (US)

(21) Appl. No.: 14/300,471

(22) Filed: Jun. 10, 2014

(51) Int. Cl. H04N 5/268; H04N 5/445; H04N 7/08; H04N 5/45

(52) U.S. Cl. CPC H04N 5/268; H04N 5/45; H04N 5/44591; H04N 7/0806; H04N 5/44543; H04N 2005/44595

(57) ABSTRACT

A system, method, and computer-readable medium are disclosed for polling a display device for a video source status and proactively generating a prompt to allow a user to proactively select a multisource video presentation mode of operation when more than one video source is detected.

### BACKGROUND OF THE INVENTION

1. Field of the Invention

The present invention relates to information handling systems. More specifically, embodiments of the invention relate to proactively select a multisource video presentation mode of operation.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to provide information handling systems or display devices with a plurality of video inputs. For example, a display device may include has several video inputs (e.g. Video Graphics Array (VGA), Digital Visual Interface (DVI), High Definition Multimedia Interface (HDMI), DisplayPort (DP), and/or a peer-to-peer wireless screen casting standard such as Miracast). Some display devices are able to display two or more video sources (e.g. via VGA and HDMI) simultaneously on the screen via a multisource video presentation mode of operation such as a Picture-By-Picture (PBP) mode of operation, where two video source presentations are presented side-by-side, or a Picture-In-Picture (PIP) mode of operation, where one video source presentation is presented as an inset window within another video source presentation.

In a typical use-case scenario of how a user might couple an external display device to a desktop type information handling system and a tablet type information handling system, the user starts the operation by connecting an external display device to a desktop type information handling system or a notebook type information handling system via a first video connection (e.g., a VGA connection). The user then instantiates an operating system (such as a Windows 7 Operating System) on the attached device. The user then connects the external display device to a tablet type information handling system (e.g. a Surface Tablet) via another video connection (e.g., an HDMI connection). The user then accesses an on-screen display (OSD) feature of the display device (e.g., by actuating an appropriate button on the external display). Next, the user navigates through the options on the OSD to select a Picture-By-Picture mode of operation. The external display device would now present a first screen presentation (e.g., a Windows 7 screen presentation) on the one portion of the display while presenting another screen presentation (e.g., a Windows RT screen presentation) on another portion of the display.

However, the process of selecting a PBP or PIP mode of operation can be challenging for many users. For example, at a minimum, the above use-case would likely require a user to have knowledge that there are PBP and PIP modes available for selection within an OSD of a display device. Many users are not aware of the PBP and PIP modes of operation or even how to access the On-Screen Display capability in the display device.

### SUMMARY OF THE INVENTION

In accordance with the present invention, a multiple video source screen presentation selection module is provided which polls a display device for a video source status and proactively generates a prompt to allow a user to proactively select a multisource video presentation mode of operation when more than one video source is detected. In various embodiments, the multiple video source screen presentation selection module executes on either an information handling system or on the display device. With certain display device implementations, the multiple video source screen presentation selection module may be stored within firmware of the display device that is equipped with its own application processor which is powerful enough to execute the module.

In certain embodiments, the multiple video source screen presentation selection module executes in the background and interacts with the display device via a Display Data Channel Command Interface (DDC/CI) protocol. The polls multiple video source screen presentation selection module the display device for the status of the video inputs. After the module detects that a second video source is connected to a display input, the module proactively prompts the user (e.g., via a dialog box) to allow a user to select an appropriate multisource video presentation mode of operation such as a PIP mode of operation and a PBP mode of operation. In certain embodiments, the multiple video source screen presentation selection module only presents available inputs to the user. For example, if the display device does not have a mobile high-definition link (MHL) input, then this input option is not be presented to the user. Additionally, in certain embodiments, the multiple video source screen presentation selection module only enables an input option if an active device is connected to that input. Additionally, in certain embodiments, the multiple video source screen presentation selection module the user is provided with an option of remembering this selection to allow the software service to automatically select the option the next time the same video source is connected to the sample input.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows s a general illustration of components of an information handling system as implemented in the system and method of the present invention.

FIG. 2 shows a flow chart of the operation of a multiple video source screen presentation selection module.

FIG. 3 shows a diagrammatic usage model representation of a plurality of sources coupled to a display device.

FIG. 4 shows diagrammatic usage model representation of a plurality of sources coupled to a display device.

FIG. 5 shows screen presentation examples of prompts proactively generated by the multiple video source screen presentation selection module.

FIG. 6 shows diagrammatic usage model representation of a plurality of sources coupled to a display device.

FIG. 7 shows diagrammatic usage model representation of a plurality of sources coupled to a display device.

FIG. 8 shows diagrammatic usage model representation of a plurality of sources coupled to a display device.

### DETAILED DESCRIPTION

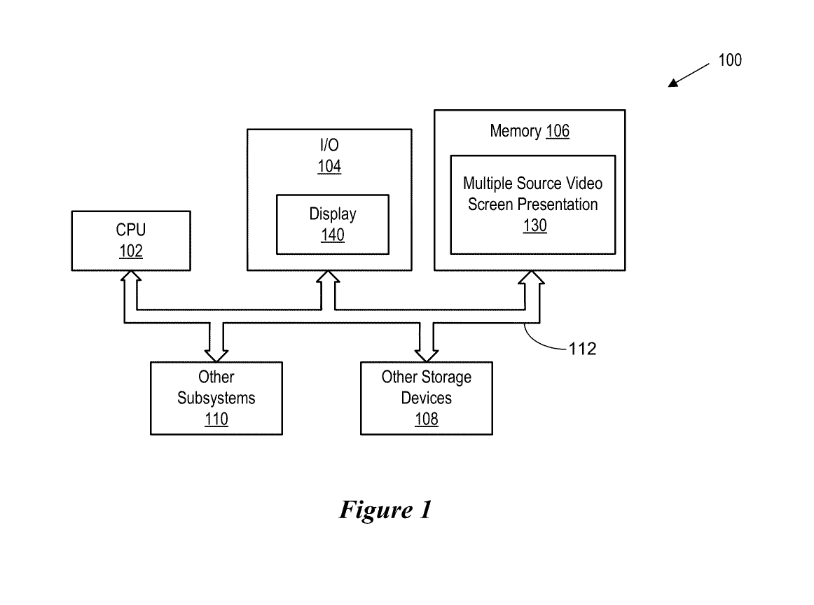

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, memory 106, and various other subsystems 108. The information handling system 100 likewise includes other storage devices 110. The components of the information handling system are interconnected via one or more buses 112. In various embodiments, the information handling system 100 further comprises a multiple video source screen presentation selection module 130 stored on the memory 104 and executable by the processor 102. In various embodiments, the I/O devices may comprise a display device 140. Additionally, in certain embodiments, the information handling system may be included within a display device.

The multiple video source screen presentation selection module 130 polls a display device for a video source status and proactively generates a prompt to allow a user to select a multisource video presentation mode of operation when more than one video source is detected. In various embodiments, the multiple video source screen presentation selection module executes 130 on either an information handling system or on the display device (which may itself be an information handling system). With certain display device implementations, the multiple video source screen presentation selection module may be stored within firmware of the display device that is equipped with its own application processor which is powerful enough to execute the module.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

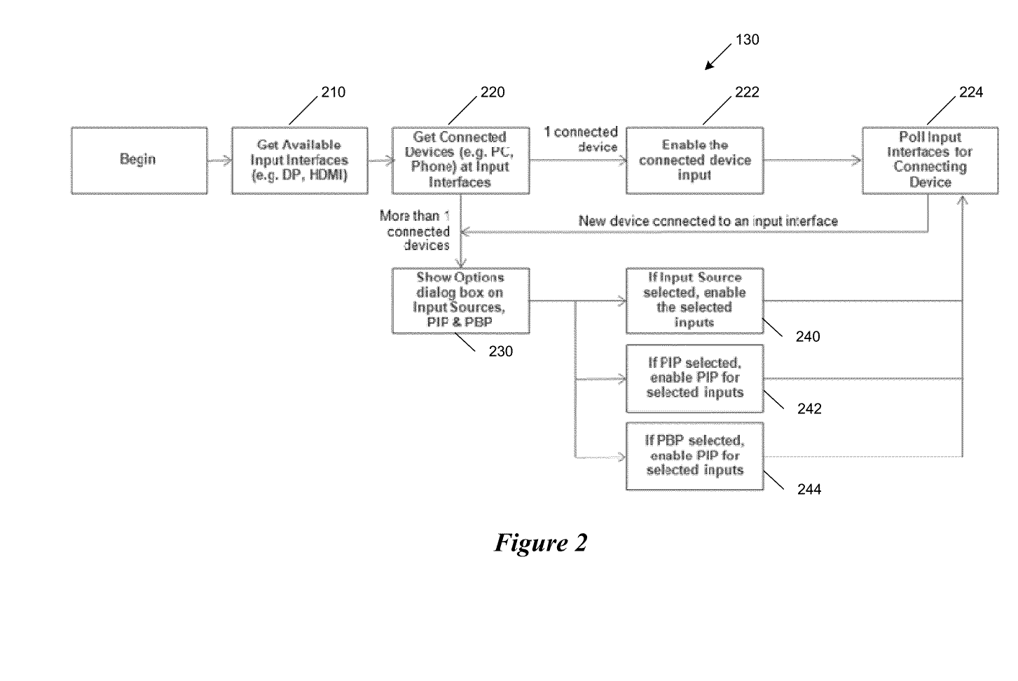

Referring to FIG. 2, a flow chart of the operation of a multiple video source screen presentation selection module 130 is shown. More specifically, the module begins operation and proceeds to obtain information regarding any available input interfaces of the information handling system at step 210. In certain embodiments, the input interfaces may include a DisplayPort (DP) interface as well as an HDMI interface. Next at step 220, the multiple video source screen presentation selection module 130 identifies which devices are coupled to which input interfaces. For example, devices which are coupled to the input interfaces may include a variety of information handling systems (e.g., a desktop, portable or tablet type information handling system) or a telephone such as a mobile smart phone. If the multiple video source screen presentation selection module 130 determines that a single device is coupled to an input interface, then the multiple video source screen presentation selection module 130 enables the coupled input device at step 222 and at step 224 continues to poll the input interfaces to determine whether any additional devices are coupled to any input interface.

If the multiple video source screen presentation selection module 130 determines more than one device is coupled to respective input interfaces at step 220 then at step 230 the multiple video source screen presentation selection module 130 proactively generates a screen presentation of prompts showing operations on input sources. Based upon these prompts a user may select a particular input source from the identified inputs upon which selection the multiple video source screen presentation selection module 130 enables the selected input source from the plurality of input sources at step 240, may select a PIP mode of operation upon which selection the multiple video source screen presentation selection module 130 enables a PIP mode of operation for the selected input source from the plurality of input sources at step 242, or may select a PBP mode of operation upon which selection the multiple video source screen presentation selection module 130 enables a PBP mode of operation for the selected input source from the plurality of input sources at step 244. After a particular mode of operation is automatically entered, the multiple video source screen presentation selection module 130 continues to poll the input interfaces to determine whether any additional devices are coupled to any input interface at step 224.

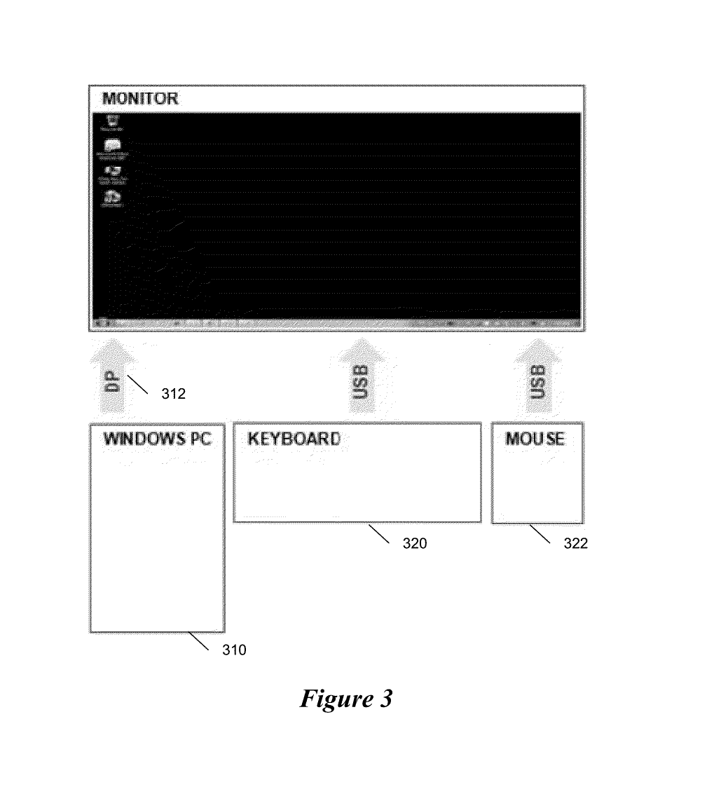

Referring to FIG. 3, a diagrammatic usage model representation of a plurality of sources coupled to a display device is shown. More specifically, an information handling system 310, such as an information handling system executing a Windows type operating system is coupled to the display device 140 via a video source input 312 such as e.g., a DisplayPort display device connector. In certain embodiments other input devices such as a keyboard 320 and a mouse 322 may also be coupled to the display device 140.

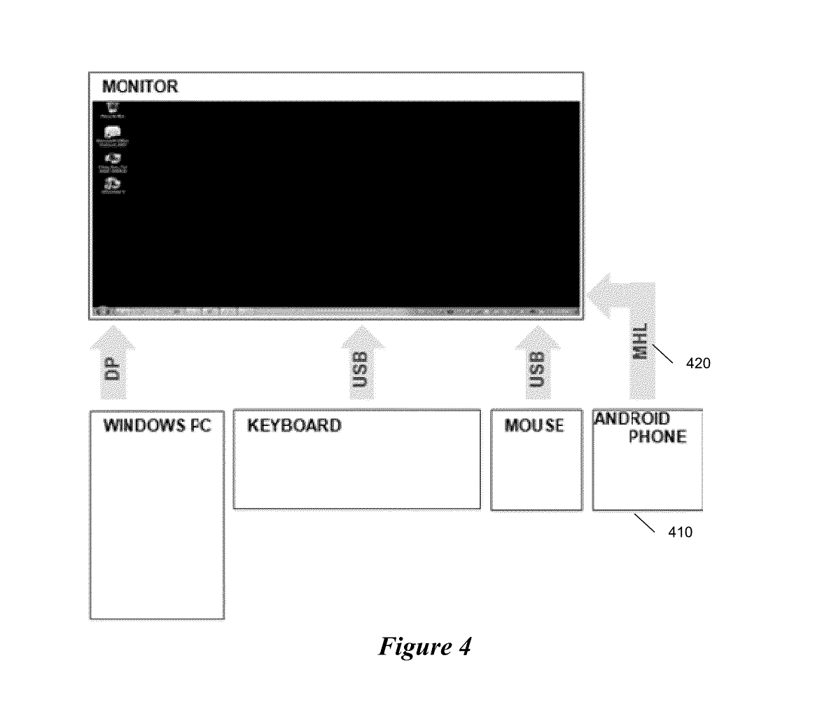

FIG. 4 shows diagrammatic usage model representation of a plurality of sources coupled to a display device. More specifically, a mobile device 410 such as a smart phone such as an Android type smart phone is coupled to the display device 140 via another video source input 420 such as e.g., a MHL video source connector, or other.

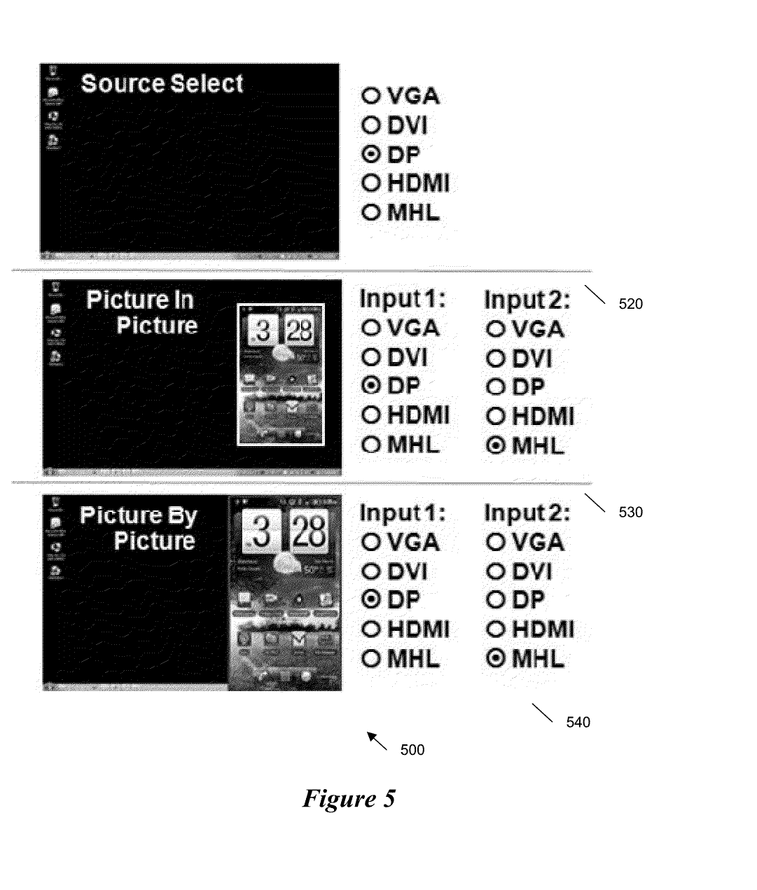

FIG. 5 shows screen presentation examples of prompts 500 proactively generated by the multiple video source screen presentation selection module 130. More specifically, when the multiple video source screen presentation selection module 130 detects a video source being coupled to the display device, the multiple video source screen presentation selection module 130 proactively generates a video source options dialog screen presentation.

When a single video source is detected as being coupled to the display device, then the multiple video source screen presentation selection module 130 generates a single video source options dialog screen presentation 520. The single video source options dialog screen presentation 520 proactively populates the selection option for the video source connector to which the video source is coupled. For example, in the single video source options dialog screen presentation 520 the multiple video source screen presentation selection module 130 detected that the video source is coupled to the DisplayPort video connection and thus shows this selection are pre-populated. Accordingly, the display device is proactively enabled for the video source input to which the video source is coupled. A user, if they so desire, may select another video input.

When a plurality of video sources are detected as being coupled to the display device, then the multiple video source screen presentation selection module 130 generates a combination of multiple video source options dialog screen presentations 520, 530, 540. The source select video source options dialog screen presentation 520 proactively populates the selection option for a predetermined video source connector to which one of the plurality the video source is coupled. For example, in the video source selection options dialog screen presentation 520, the multiple video source screen presentation selection module 130 detected that one of the video sources is coupled to the DisplayPort video connection and thus shows this selection are pre-populated. Accordingly, the display device is proactively enabled for the video source input to which the video source is coupled. A user, if they so desire, select another video input. This function allows a user to access the video devices immediately without requiring an extra step of accessing an Options dialog option of the display device.

The user is also presented with a plurality of multiple video source screen presentation options 530, 540. These multiple video source screen presentation options include a picture-in-picture screen presentation option 530 and a picture-by-picture screen presentation option 540. Each of these options is visually represented with the actual video sources to provide a user of a representation of how these multiple video source screen presentations will appear on the display device. Each of these options also include a representation of which video source is coupled to which video input. These inputs may be changed to adjust which video source is displayed at a particular location. As the inputs are changed, so too is the visual representation of the video sources to provide the user with a representation of how the changes would affect the screen presentation.

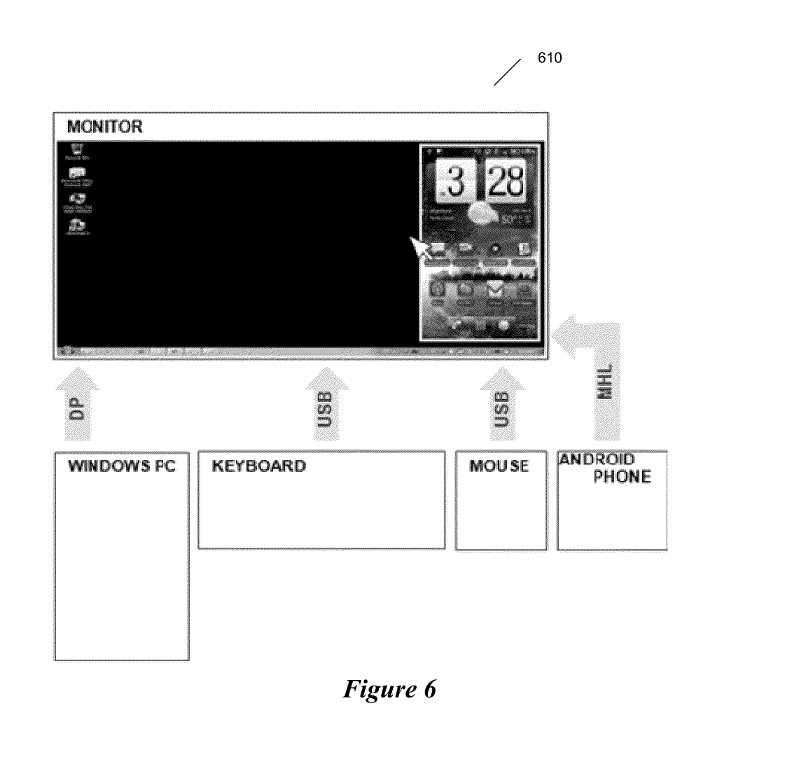

FIG. 6 shows diagrammatic usage model representation of a plurality of sources coupled to a display device. More specifically, when a user selects a picture-in-picture presentation option from the source select video source options dialog screen presentation, the multiple video source screen presentation selection module 130 automatically configures the display device to present a picture-in-picture screen presentation 610 with the video sources presented as they were demonstrated in the visual representation of the video sources shown in the source select video source options dialog screen presentation

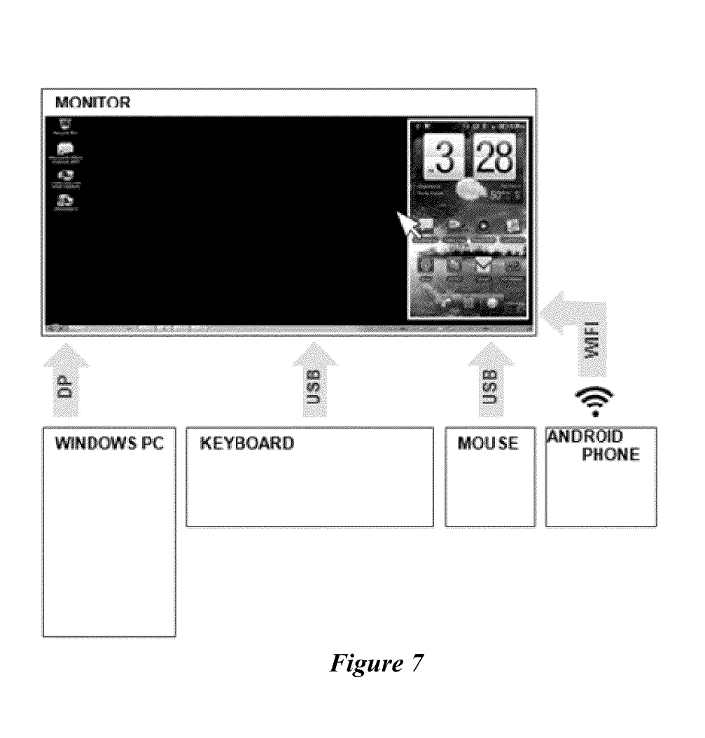

FIG. 7 shows diagrammatic usage model representation of a plurality of sources coupled to a display device. More specifically, an information handling system 310, such as an information handling system executing a Windows type operating system is coupled to the display device 140 via a video source input 312 such as e.g., a DisplayPort display device connector. In certain embodiments other input devices such as a keyboard 320 and a mouse 322 may also be coupled to the display device 140. Additionally, a mobile device 410 such as a smart phone such as an Android type smart phone is coupled to the display device 140 via a wireless video source input 420 such as e.g., a wireless network interface (WIFI) type video source connector.

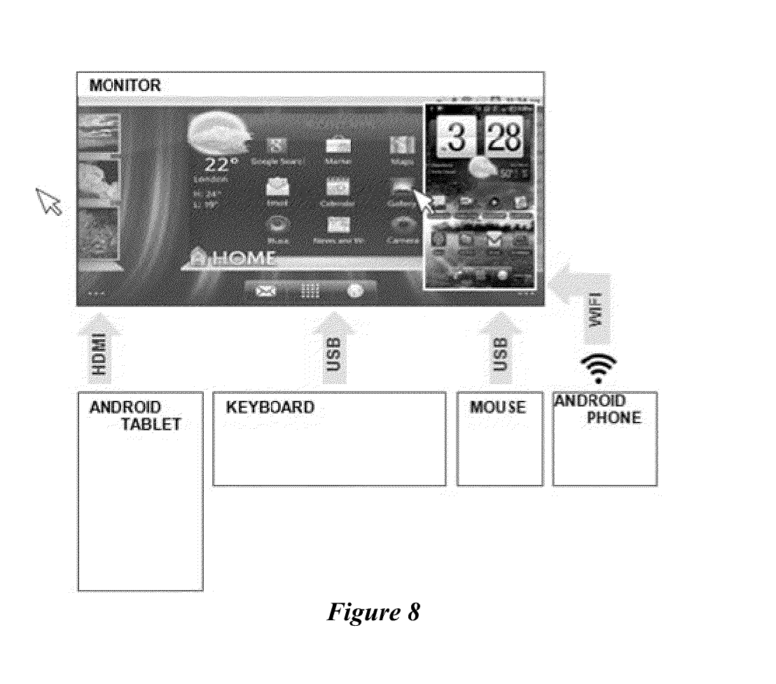

FIG. 8 shows diagrammatic usage model representation of a plurality of sources coupled to a display device. More specifically, an information handling system 310, such as a tablet type information handling system executing an Android type operating system is coupled to the display device 140 via a video source input 312 such as e.g., an HDMI display device connector. Additionally, a mobile device 410 such as a smart phone such as an Android type smart phone is coupled to the display device 140 via a wireless video source input 420 such as e.g., a Wi-Fi video source connector. In certain embodiments other input devices such as a keyboard 320 and a mouse 322 may also be coupled to the display device 140.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for enabling selection of a multisource video presentation mode of operation, comprising:
polling a display device for a video source status;
detecting whether more than one video sources is coupled to the display device via the polling; and
proactively generating a prompt to allow a user to select a multisource video presentation mode of operation when more than one video source is detected.

2. The method of claim 1, wherein:
the proactively generating the prompt is via one of an information handling system or on the display device.

3. The method of claim 2, wherein:
when the proactively generating is via the display device, instructions for performing the proactively generating are stored within firmware of the display device and the instructions are executed on a processor within the display device.

4. The method of claim 1, wherein:
the multisource video presentation mode of operation comprises a picture-in-picture (PIP) mode of operation and a picture-by-picture (PBP) mode of operation.

5. The method of claim 1, wherein:
the prompt comprises a screen presentation representing each available video presentation mode of operation.

6. The method of claim 1, wherein:
the prompt for the multiple video source screen presentation mode of operation performs at least one of only presenting available inputs to the user and preselecting input for the display device based upon the detecting.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
polling a display device for a video source status;
detecting whether more than one video sources is coupled to the display device via the polling; and
proactively generating a prompt to allow a user to select a multisource video presentation mode of operation when more than one video source is detected.

8. The system of claim 7, wherein:
the proactively generating the prompt is via one of an information handling system or on the display device.

9. The system of claim 8, wherein:
when the proactively generating is via the display device, instructions for performing the proactively generating are stored within firmware of the display device and the instructions are executed on a processor within the display device.

10. The system of claim 7, wherein:
the multisource video presentation mode of operation comprises a picture-in-picture (PIP) mode of operation and a picture-by-picture (PBP) mode of operation.

11. The system of claim 7, wherein:
the prompt comprises a screen presentation representing each available video presentation mode of operation.

12. The system of claim 7, wherein:
the prompt for the multiple video source screen presentation mode of operation performs at least one of only presenting available inputs to the user and preselecting input for the display device based upon the detecting.

13. A non-transitory, computer-readable storage medium embodying computer program code, the computer program code comprising computer executable instructions configured for:
polling a display device for a video source status;
detecting whether more than one video sources is coupled to the display device via the polling; and
proactively generating a prompt to allow a user to select a multisource video presentation mode of operation when more than one video source is detected.

14. The non-transitory, computer-readable storage medium of claim 13, wherein:
the proactively generating the prompt is via one of an information handling system or on the display device.

15. The non-transitory, computer-readable storage medium of claim 14, wherein:
when the proactively generating is via the display device, instructions for performing the proactively generating are stored within firmware of the display device and the instructions are executed on a processor within the display device.

16. The non-transitory, computer-readable storage medium of claim 13, wherein:
the multisource video presentation mode of operation comprises a picture-in-picture (PIP) mode of operation and a picture-by-picture (PBP) mode of operation.

17. The non-transitory, computer-readable storage medium of claim 13, wherein:
the prompt comprises a screen presentation representing each available video presentation mode of operation.

18. The non-transitory, computer-readable storage medium of claim 13, wherein:
the prompt for the multiple video source screen presentation mode of operation performs at least one of only presenting available inputs to the user and preselecting input for the display device based upon the detecting.
